(19) United States
(12) Patent Application Publication
(10) Pub. No.: US 2014/0133169 A1
(43) Pub. Date: May 15, 2014

(54) LIGHTING DEVICE INCLUDING SEMICONDUCTOR LIGHT SOURCE

(71) Applicant: OSRAM GmbH, Muenchen (DE)

(72) Inventors: Stephan Schwaiger, Ulm (DE); Juergen Hager, Heidenheim (DE); Oliver Hering, Niederstotzingen (DE); Jasmin Muster, Heidenheim (DE); Philipp Helbig, Heidenheim (DE)

(73) Assignee: OSRAM GmbH, Muenchen (DE)

(21) Appl. No.: 14/071,686

(22) Filed: Nov. 5, 2013

(30) Foreign Application Priority Data
Nov. 9, 2012 (DE) 10 2012 220 455.5

(51) Int. Cl. F21S 8/10; F21K 99/00

(52) U.S. Cl. CPC F21S 48/115; F21K 9/00
USPC 362/516; 362/235

(57) ABSTRACT

A lighting device may include a carrier, on which at least one semiconductor light source is arranged; and may have at least one main reflector, which arches over the at least one semiconductor light source; wherein at least one local reflector, which is likewise arched over by the main reflector, is arranged on the carrier.

### CROSS-REFERENCE TO RELATED APPLICATION

This application claims priority to German Patent Application Serial No. 10 2012 220 455.5, which was filed Nov. 9, 2012, and is incorporated herein by reference in its entirety.

### TECHNICAL FIELD

Various embodiments relate to a lighting device, having a carrier, on which at least one semiconductor light source is arranged, and having at least one main reflector, which arches over the at least one semiconductor light source. Various embodiments are usable, for example, for vehicle lighting, e.g. for motor vehicles, e.g. as or in conjunction with a headlamp.

### BACKGROUND

DE 10 2009 022 723 A1 discloses an LED module to be applied rearward for a combination tail light. One or more LEDs are mounted on a circuit board, which mechanically holds them at the focal point of a faceted parabolic reflector. Light from the LEDs diverges transversely and horizontally and is collimated by the reflector, and the reflected collimated light is generally directed in a longitudinal direction from the combination tail light in the direction toward the observer. The LED module itself is generally oriented in the longitudinal direction and insertable from a hole at the apex of the reflector in the longitudinal direction into the interior of the reflector. The circuit board, an optional thermal pad adjacent to the circuit board and a thermally conductive layer adjacent to the optional thermal pad are all generally planar layers, generally mutually parallel and may optionally all have the same bearing surface. Together, the circuit board, the thermal pad and the thermally conductive layer may all form a generally planar strip.

EP 1 371 901 A2 discloses a lamp, which includes LED light sources that are arranged around a lamp axis in an axial arrangement. The lamp includes a post having post facets, on which the LED sources are mounted.

### SUMMARY

A lighting device may include a carrier, on which at least one semiconductor light source is arranged; and may have at least one main reflector, which arches over the at least one semiconductor light source; wherein at least one local reflector, which is likewise arched over by the main reflector, is arranged on the carrier.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a lighting device according to a first embodiment as a sectional representation in side view;

FIG. 2 shows a lighting device according to a second embodiment as a sectional representation in side view;

FIG. 3 shows a lighting device according to a third embodiment as a sectional representation in side view;

FIG. 4 shows a lighting device according to a fourth embodiment as a sectional representation in side view;

FIG. 5 shows a lighting device according to a fifth embodiment as a sectional representation in side view;

FIG. 6 shows a lighting device according to a sixth embodiment as a sectional representation in side view;

FIG. 7 shows a lighting device according to a seventh embodiment as a sectional representation in side view;

FIG. 8 shows a lighting device according to an eighth embodiment as a sectional representation in side view; and

FIG. 9 shows a lighting device according to a ninth embodiment in a view from the front.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

In various embodiments, the lamp contains a segmented reflector for guiding light from light-emitting duide (LED) light sources. The segmented reflector contains reflective segments, of which each is primarily illuminated by light from one of the post facets (for example one of the LED light sources on the post).

The LED light sources may consist of one or more LED chips. The LED chips may include lenses, in order to guide the light of each post facet to a corresponding reflective segment. The LED chips may be selected in various sizes and colors, in order to generate a particular far-field pattern.

Various embodiments at least partially overcome the disadvantages of the prior art and, for example, to provide a lighting device of the type mentioned in the introduction, the light emission pattern of which can be locally varied in a particularly simple way.

Various embodiments provide a lighting device, having a carrier, on which at least one semiconductor light source is arranged, and having at least one reflector (referred to below without restriction of generality as a “main reflector”), which arches over the at least one semiconductor light source, wherein at least one (further) reflector (referred to below without restriction of generality as a “local reflector”), which is likewise arched over by the main reflector, is arranged on the carrier.

This lighting device may have the advantage that, in a compact and straightforward way, a light emission pattern emitted by the lighting device can be varied, e.g. its intensity distribution. In various embodiments, high-intensity and low-intensity regions may in this way be provided with high accuracy. Furthermore, the local reflector may be used as a mask, for example in order to produce a bright/dark boundary and/or to shade a subregion of the main reflector, and specifically without a practically significant efficiency loss of the lighting device.

In various embodiments, the at least one semiconductor light source includes at least one light-emitting diode. When there are a plurality of light-emitting diodes, these may illuminate in the same color or in different colors. A color may be monochromatic (for example red, green, blue, etc.) or polychromatic (for example white). The light emitted by the at least one light-emitting diode may also be infrared light (IR-LED) or ultraviolet light (UV-LED). A plurality of light-emitting diodes may generate mixed light; for example, white mixed light. The at least one light-emitting diode may contain at least one light wavelength-converting luminous material (conversion LED). The luminescent material may, alternatively or in addition, be arranged at a distance from the light-emitting diode (“remote phosphor”). The at least one light-emitting diode may be in the form of at least one individually packaged light-emitting diode or in the form of at least one LED chip. A plurality of LED chips may be mounted on a common substrate (“submount”). The at least one light-emitting diode may be equipped with at least one optical unit of its own and/or a common optical unit for beam guiding, for example at least one Fresnel lens, collimator, and so on. Instead of or in addition to inorganic light-emitting diodes, for example based on InGaN or AlInGaP, organic LEDs (OLEDs, for example polymer OLEDs) are generally also usable. As an alternative, the at least one semiconductor light source may for example include at least one diode laser.

That the main reflector arches over the at least one semiconductor light source may, in various embodiments, include the case that the main reflector lies above the at least one semiconductor light source. In various embodiments, a main emission direction of the at least one semiconductor light source may be directed with the highest intensity at the main reflector.

The main reflector may, for example, be a parabolic reflector surface, which may optionally be faceted. The shape of the reflector surface of the main reflector is not, however, restricted in principle.

It is a configuration that the at least one local reflector is produced separately, or is a separately produced component. The local reflector may, for example, have been applied onto the carrier by means of a conventional application method (for example “pick & place”), i.e. it is a fitted component. This configuration may have the advantage that the carrier itself can be configured more straightforwardly. Furthermore, in this way a high configuration variability can be achieved by individual application of different local reflectors onto the carrier.

The local reflector may for example be adhesively bonded or soldered onto the carrier, and may for example be in the form of an SMD (surface mount device) component. In an additional or alternative refinement, the local reflector may be (directly or indirectly) fitted onto the carrier. For the fitting, the local reflector may for example be fitted into at least one borehole of the carrier.

It is also a refinement that at least one local reflector is formed integrally with the carrier. This means that a region of the carrier is shaped to form a reflector. The local reflector or reflector region of the carrier may, for example, be shaped by a corresponding casting mold or by a finishing operation on the carrier, for example by processing which displaces material or removes material.

The carrier may, for example, be a circuit board, a metal body, e.g. of aluminum, a ceramic body or a plastic body. The carrier may e,g, be in the form of a plate, with the main reflector e.g. arching over at least one of the two sides of the plate. The shape of the carrier may in principle be selected freely, a planar bearing surface for both the semiconductor light source(s) and the at least one local reflector being provided in various embodiments.

At least one semiconductor light source may in general be fastened directly on the carrier, for example adhesively bonded, fitted or soldered thereon. As an alternative or in addition, at least one semiconductor light source may be fastened on the carrier by means of a carrier frame fastened on the carrier, i.e. indirectly by means of an intermediate part carrying the at least one semiconductor light source.

It is a refinement that at least one local reflector is positioned further rearward on the carrier than at least one semiconductor light source illuminating it. That is to say, the local reflector is for example positioned further away from a light exit opening or closer to a rearward end of the lighting device, e.g. of the main reflector. In this way, the light shone by the at least one semiconductor light source onto this local reflector can be emitted forward in a straightforward way, for example directly through a light exit opening or indirectly via the main reflector.

It is yet another refinement that at least one local reflector is positioned further forward on the carrier than at least one semiconductor light source illuminating it. That is to say, the local reflector is for example positioned along a longitudinal direction of the lighting device, closer to a light exit opening or further away from a rearward end of the lighting device, e.g. of the main reflector. In this way, firstly the light shone by the at least one semiconductor light source onto this local reflector, which would otherwise be emitted forward, can be blocked (for example in order to form a bright/dark boundary), in which case the light shone onto the local reflector is not lost but can be directed onto the main reflector.

It is a configuration that the at least one semiconductor light source includes a plurality of semiconductor light sources and at least one local reflector is arranged between at least two of the semiconductor light sources. For these semiconductor light sources, the local reflector may on the one hand serve as a reflector, and on the other hand serve as a mask, or may serve on both sides as a reflector. The shape, size and/or orientation of the reflector surfaces for the semiconductor light sources arranged on both sides may be the same or different.

At least one local reflector may, however, also be oriented along a longitudinal direction of the lighting device, i.e. in various embodiments may separate semiconductor light sources into right and left groups.

It is a general configuration that at least one local reflector is adapted and arranged as a reflector for at least one of the semiconductor light sources and as a mask (i.e. without reflective property) for at least one further of the semiconductor light sources, particularly if it is arranged between semiconductor light sources.

It is furthermore a configuration that at least one local reflector is adapted and arranged in order to direct light of at least one semiconductor light source at least partially onto the main reflector. Thus, in various embodiments, predetermined subregions of a light emission pattern may in this way be reinforced in a straightforward way.

It is furthermore a configuration that at least one local reflector is adapted and arranged in order to direct light of at least one semiconductor light source at least partially directly out of a light exit opening of the main reflector. This allows even more versatile configuration of the light emission pattern, since the shape of the main reflector does not need to be taken into account for the directly emitted light.

It is furthermore a configuration that at least one local reflector is adapted and arranged in order to direct light of at least one semiconductor light source at least partially through an opening in the carrier. In this way, light can be guided through the carrier to its side facing away therefrom. This allows even greater variation of the light emission pattern, e.g. outside a region which is bounded by the free or front edge of the main reflector.

It is a refinement that at least one local reflector is a reflector protruding from the carrier, e.g. protruding perpendicularly, which extends to above the semiconductor light sources. In this way, in various embodiments, lateral reflection surfaces can be provided.

It is also a refinement that at least one local reflector is a “floatingly” arranged reflector, the reflection surface of which lies e.g. fully above at least one semiconductor light source. The reflection surface may e.g. be placed parallel or obliquely, e.g. at an attitude angle <45°, with respect to a bearing surface of the carrier, which also carries at least one semiconductor light source.

It is also a refinement that at least one local reflector arches over at least one semiconductor light source arched over by the main reflector. In various embodiments, at least one other semiconductor light source arched over by the main reflector may not include such a local reflector.

It is a refinement that such a reflector extends laterally beyond a semiconductor light source arched over by it, to the extent that the light shone by this semiconductor light source no longer strikes the main reflector. In this way, the light emission pattern can be configured even more variably.

It is yet another configuration that the main reflector is a half-dish reflector. This may be suitable for use with a headlamp.

It is also a further configuration that the main reflector is a full-dish reflector. A full-dish reflector permits a particularly large-area light emission pattern. The full-dish reflector may be formed in one piece, or in a plurality of pieces, for example from two half-dish reflectors.

It is furthermore a configuration that the carrier is a carrier equipped on two sides and the at least one semiconductor light source of each side illuminates a corresponding half-dish of the full-dish reflector.

It is generally a configuration that the device is a vehicle lighting device.

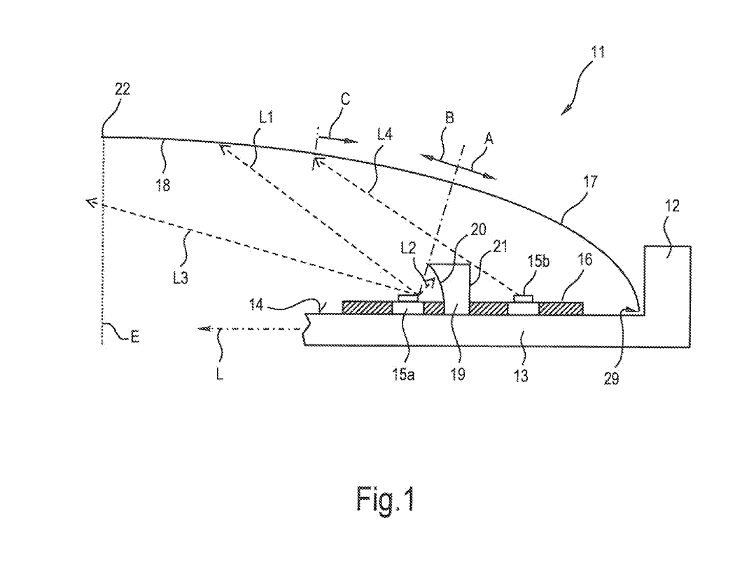

FIG. 1 shows a lighting device 11 as a sectional representation in side view, for example as a vehicle headlamp or for a vehicle headlamp. The lighting device 11 includes a carrier 12 which has a plate-like section 13. The carrier 12 and/or the plate-like section 13 may for example be formed as a circuit board, ceramic body, plastic body and/or metal body, here for example as a solid aluminum body or having a solid aluminum body. The carrier 12 may be connected on the rear side, for example, to a heat sink (not shown).

On one side of the section 13, which here without restriction of generality is referred to as the upper side 14, a plurality of semiconductor light sources, heir for example in the form of two light-emitting diodes 15a, 15b, are applied indirectly. The light-emitting diodes 15a, 15b are, more precisely, fastened on a carrier frame 16 which is in turn fastened on the upper side 14 of the section 13 of the carrier 12. Nevertheless, the light-emitting diodes 15a, 15b may as an alternative also be applied directly on the carrier 12. The two light-emitting diodes 15a, 15b may e.g. be upwardly emitting light-emitting diodes, that is to say their main emission direction is oriented perpendicularly to their bearing surface, i.e. perpendicularly upward.

The plate-like section 13 of the carrier 12 may, for example, be inserted in a similar way as described in DE 10 2009 022 723 A1 rearward into a neck opening 29 of a reflector, here by way of example a main reflector 17 in the form of a half-dish. The main reflector 17 may, for example, include a parabolically shaped inner reflection surface 18. The main reflector 17 arches over the section 13 inserted therein of the carrier 12, which carries the light-emitting diodes 15a, 15b.

In addition, a local reflector 19 is arranged on the support frame 16, and therefore also on the carrier 12, between the two light-emitting diodes 15a, 15b. The local reflector 19 is thus likewise arched over by the main reflector 17 and may, in various embodiments, be a previously separately produced fitted component. The local reflector 19 has a curved reflection surface 20 facing toward the front light-emitting diode 15a and a light-absorbing plane mask surface 21 facing toward the backward or rear light-emitting diode 15b. The local reflector 19 to this end protrudes from the carrier 12 to above the light-emitting diodes 15 and the carrier frame 16.

The front light-emitting diode 15a thus shines a large part L1 of its light onto the inner reflection surface 18 of the main reflector 17, and a smaller part L2 onto the reflection surface 20 of the local reflector 19. The light L2 shone into the local reflector 19, or onto the reflection surface 20, is reflected through a light exit opening E which is defined by a free edge 22 of the main reflector 17. The light L2 is preferably shone into the vicinity of a bright/dark boundary of a low-beam light emission pattern of an ECE-compliant lighting device 11. A small fraction 13 of the light emerges directly from the light exit opening E.

The local reflector 19 also acts as a mask for the front light-emitting diode 15a, in the sense that it shades a region A of the reflection surface 18 so that only a remaining region B is illuminated by the front light-emitting diode 15a. Similarly, only a region C of the reflection surface 18 is illuminated by light L4 of the rear light-emitting diode 15b. Thus, dazzling by direct observation of the rear light-emitting diode 15b through the light exit opening E can be prevented. The shape of the regions A to C may, for example, also be adjusted by the selection of the height of the local reflector 19 above the carrier L3.

The light emission pattern of the lighting device 11 can be configured particularly flexibly, e.g. for the case in which the light-emitting diodes 15a, 15b are differently configured, for example emitting light of a different color, for example cold-white and warm white or white, or infrared. The term “warm white” denotes white light having a color temperature in the range of about 2700-3300 kelvin, corresponding to the light emitted by incandescent lamps. The term “cold-white” denotes white light having a color temperature in the range of about 3300-5000 kelvin.

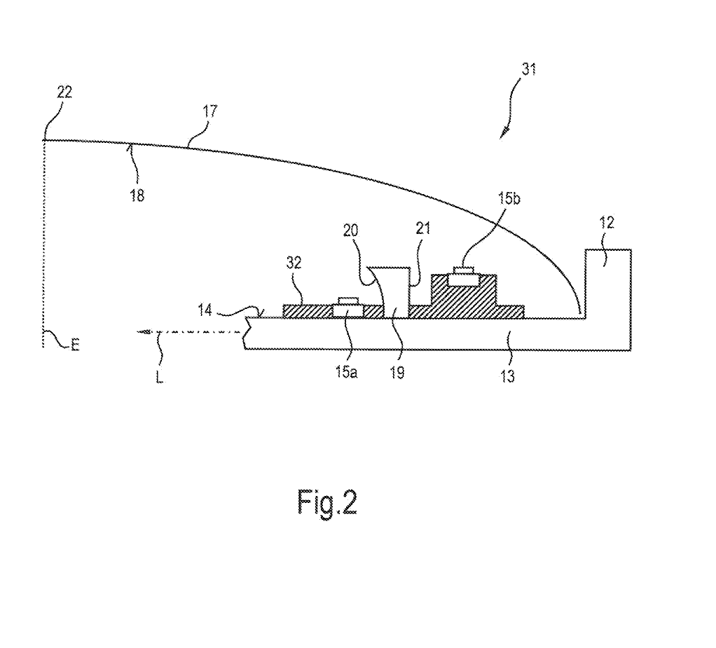

FIG. 2 shows a lighting device 31 similar to the lighting device 11 as a sectional representation in side view, the carrier frame 32 now being configured in such a way that the rear light-emitting diode 15b is elevatedly positioned, so that the local reflector 19 no longer blocks its light.

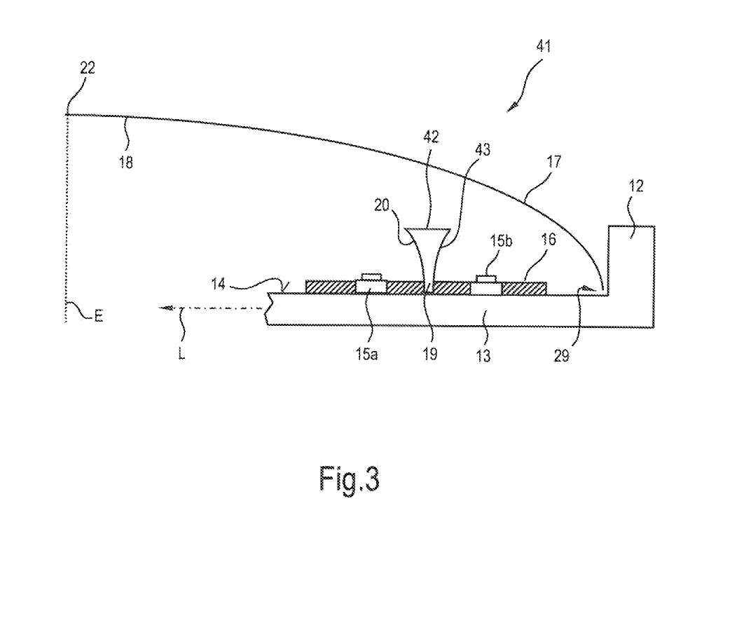

FIG. 3 shows a lighting device 41 similar to the lighting device 11 as a sectional representation in side view, the local reflector 42 now also serving as a reflector for the rear light-emitting diode 15b and to this end having a rearwardly directed reflection surface 43. This increases an efficiency of the lighting device 41 and permits even stronger variation of the light emission pattern. The light striking the reflection surface 43 is to this end reflected onto the main reflector 17. The local reflector 42 furthermore exerts a shading effect on light emitted by the rear light-emitting diode 15b.

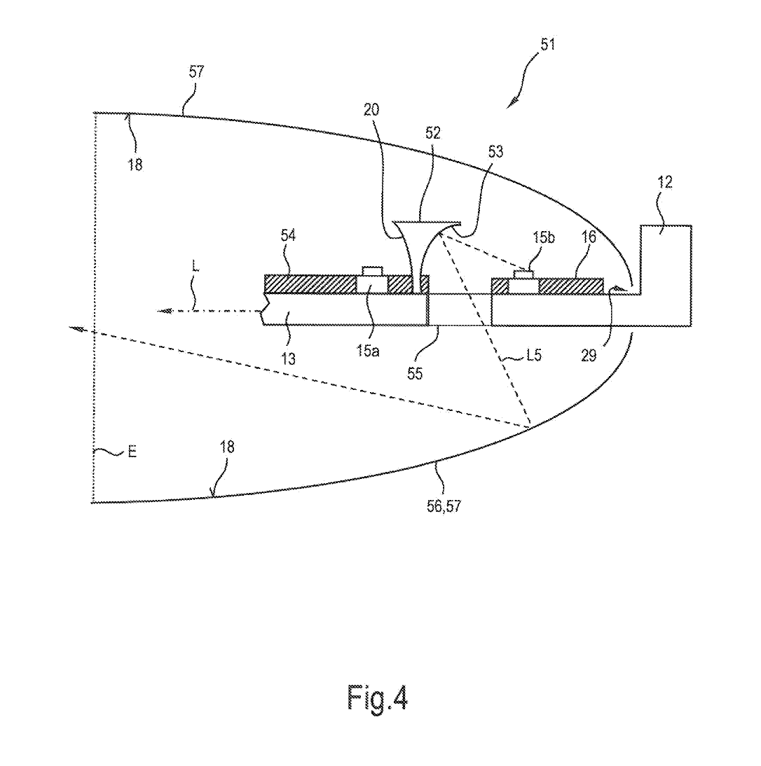

FIG. 4 shows a lighting device 51 similar to the lighting device 41 as a sectional representation in side view, an opening 55, through which light L5 emitted by the rear light-emitting diode 15b and reflected on the rearwardly directed reflection surface 53 can pass, being present between the local reflector 52 and the rear light-emitting diode 15b in the carrier 12 and the carrier frame 54. In a similar way to a “virtual light source”, the light L5 shone through the opening 55 strikes a lower region 56, in the form of a half-dish, of the main reflector 57, which in this case is formed as a full-dish reflector (in one piece or a plurality of pieces), and is emitted further through the light exit opening E. The carrier 12 may, as shown, be fitted with components on one side, or it may be fitted with components on both sides. The local reflector 52 furthermore exerts a shading effect on the light emitted by the rear light-emitting diode 15b.

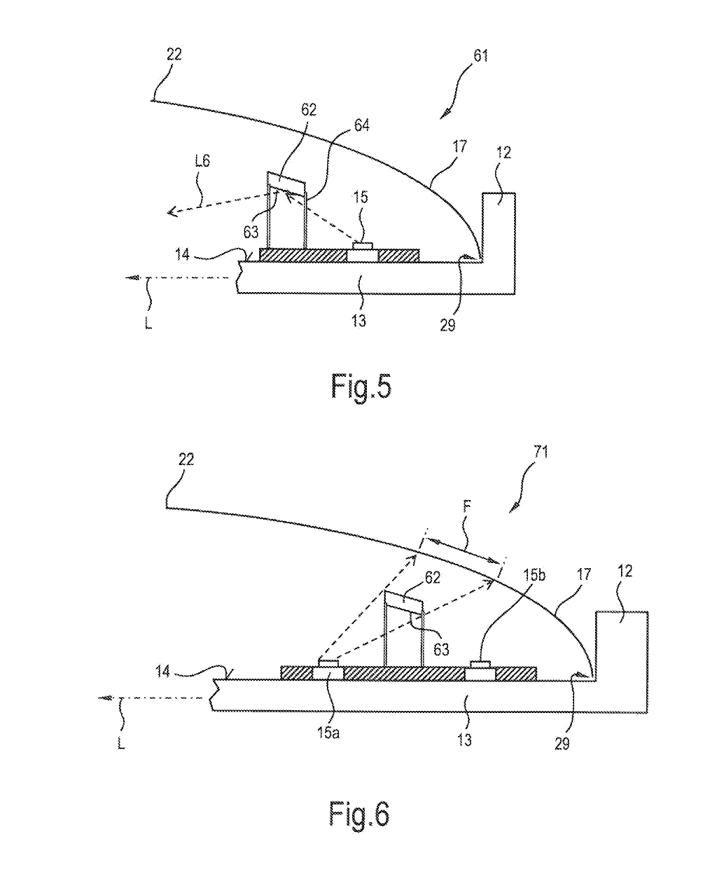

FIG. 5 shows, as a sectional representation in side view, a lighting device 61 in which the local reflector 62 is now a quasi-floatingly arranged reflector. The local reflector 62 is arranged above a light-emitting diode 15, the light-emitting diode 15 illuminating its reflectively formed lower side 63. The fixing of the local reflector 62 on the carrier 12 may, for example, be carried out by means of thin supports 64. This, in various embodiments, permits deviation of the light L6, shone onto the reflector 62 by a light-emitting diode 15 arranged further behind on the carrier 12, into a forward direction. At the same time, the local reflector 62 acts as a shading element for directly emitted light of the light-emitting diode 15. The local reflector 62 may have a lower side facing toward the carrier 13, which includes surface elements acting as a reflector that, for example, may be planar or convex or concavely curved. These surface elements are not shown in the figures. The local reflector 62 may be formed as an extended three-dimensional web and have any desired shape and size.

FIG. 6 shows, as a sectional representation in side view, a lighting device 71 similar to the lighting device 61 represented in FIG. 5, in which the local reflector 62 is now arranged between two light-emitting diodes 15a, 15b and furthermore also acts as a mask. In this way it can also be used as a mask, e.g. for the front light-emitting diode 15a, so that a region F not illuminated by the front light-emitting diode 15a is formed on the main reflector 17.

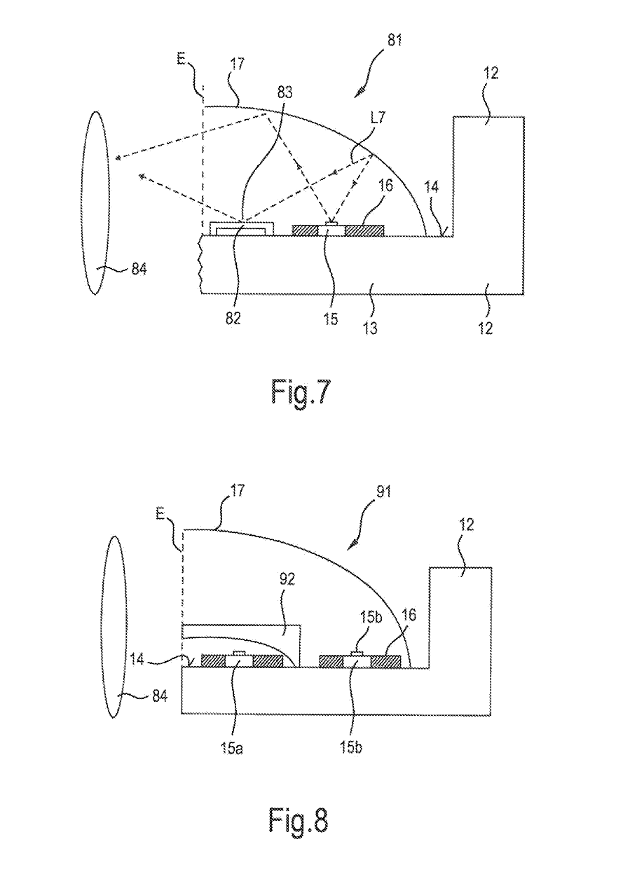

FIG. 7 shows, as a sectional representation in side view, a lighting device 81 in which the local reflector 82 is now not as high as the light-emitting diode 15 and has a reflection surface 83 which is parallel or at least only slightly oblique with respect to the upper side 14 of the carrier 12. An efficiency can thus be increased, since light L7 shone by the main reflector 17 onto the reflection surface 83 can still be reflected through the light exit opening E. Such a case may, for example, arise when the luminous surface of the light-emitting diode(s) 15 does not fully lie at the focal point of the main reflector 17, for example owing to tolerances in adjustment. The reflection surface 83, on the other hand, is not illuminated directly by the light-emitting diodes 15. Behind the light exit opening E, there is also an optical unit indicated by a lens 84.

FIG. 8 shows, as a sectional representation in side view, a lighting device 91 in which the local reflector 92 arches over a light-emitting diode 15a. In this way, the light of selected light-emitting diodes 15a can selectively be emitted from the light exit opening E without reflection on the main reflector 17. The local reflector 92 acts as a shade for light from the rear light-emitting diode 15b, so that direct light from the light-emitting diode 15b cannot reach the light exit opening E without reflection on the main reflector 17. As an alternative, the light-emitting diode 15b may also be arranged elevated above the carrier section 13, so that the light from the light-emitting diode 15b is only partially shaded by the local reflector 92.

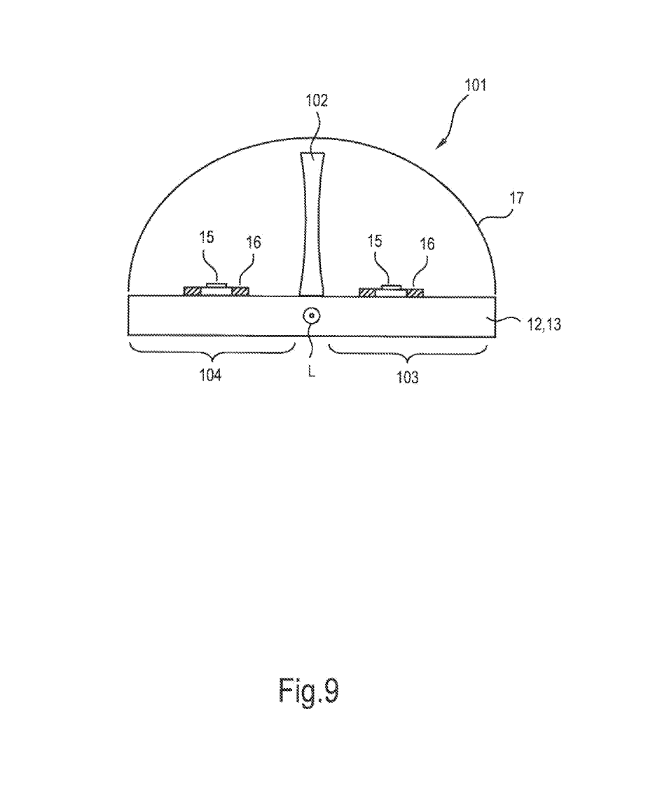

FIG. 9 shows a lighting device 101 according to a ninth embodiment in a view of the light exit opening E from the front. A local reflector 102 is now oriented along a longitudinal axis L and divides the carrier 12 here into a part 103 on the left in the direction of the longitudinal axis L and a right part 104, on each of which there are light-emitting diodes 15. The local reflector 102 to this end protrudes perpendicularly from the carrier 12, 13 and is formed reflectively on both sides. In this way, in various embodiments, an individual configuration of a left region and a right region of a light emission pattern can be generated by means of the two reflectors 101 for the right and the left. As an alternative, the local reflector 102 may also comprise light-absorbing surfaces and act as a mask.

In all the embodiments, the main reflector 17 and the local reflector 19 consist, for example, of plastics having metallized reflection surfaces or reflective surfaces consisting of metal.

Although the invention has been illustrated and described in detail by the embodiments shown, the invention is not restricted thereto and other variants may be derived therefrom by the person skilled in the art without departing from the protective scope of the invention.

Thus, elements of the lighting devices may also be combined with one another. For example, the local reflectors may extend over the entire width of the main reflector or be spatially limited in this direction. The width in this case refers to a direction perpendicular to the longitudinal axis 1 and parallel to the surface of the carrier 12 (perpendicular to the plane of the drawing page in FIG. 1 to FIG. 9). Furthermore, the reflection surfaces of all the reflectors may be formed as freeform surfaces.

Thus, the installation length of the carrier in relation to the main reflector is not restricted, and e.g. not restricted to the arrangement as shown above of the section 13 of the carrier 12 along a principal optical plane of the main reflector.

Features of different embodiments may also be replaced with one another or combined. For example, the light-emitting diodes may in principle be arranged at the same height or at least partially at a different height above the carrier (as for example in the case of the lighting device 31).

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A lighting device, comprising:
a carrier, on which at least one semiconductor light source is arranged; and having at least one main reflector, which arches over the at least one semiconductor light source;
wherein at least one local reflector, which is likewise arched over by the main reflector, is arranged on the carrier.

2. The lighting device of claim 1,
wherein the at least one semiconductor light source comprises a plurality of semiconductor light sources and at least one local reflector is arranged between at least two of the semiconductor light sources.

3. The lighting device of claim 1,
wherein at least one local reflector is adapted and arranged as a reflector for at least one of the semiconductor light sources and as a mask for at least one further of the semiconductor light sources.

4. The lighting device of claim 1,
wherein the at least one local reflector has been produced separately.

5. The lighting device of claim 1,
wherein at least one local reflector is adapted and arranged in order to direct light of at least one semiconductor light source at least partially onto the main reflector.

6. The lighting device of claim 1,
wherein at least one local reflector is adapted and arranged in order to direct light of at least one semiconductor light source at least partially out of a light exit opening of the main reflector.

7. The lighting device of claim 1,
wherein at least one local reflector is adapted and arranged in order to direct light of at least one semiconductor light source at least partially through an opening in the carrier.

8. The lighting device of claim 1,
wherein the main reflector is a half-dish reflector.

9. The lighting device of claim 1,
wherein the main reflector is a full-dish reflector.

10. The lighting device of claim 1,
wherein the carrier is a carrier equipped on two sides and the at least one semiconductor light source of each side illuminates at least one corresponding half-dish of the full-dish reflector.

11. The lighting device of claim 1,
wherein the device is a vehicle lighting device.
